(19) United States
(12) Patent Application Publication
(10) Pub. No.: US 2003/0196169 A1
(43) Pub. Date: Oct. 16, 2003

(54) Device and procedure for the protected output of an electronic document via a data transmission network

(76) Inventors: Erland Wittkotter, Ermatingen (CH); Marcus A. Schuerstedt, Diedorf (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/138,383

(22) Filed: May 2, 2002

Related U.S. Application Data
(63) Continuation of application No. PCT/EP00/10750, filed on Oct. 31, 2000.

(51) Int. Cl. G06F 17/24

(52) U.S. Cl. 715/513

(57) ABSTRACT

The invention relates to a device for the protected output of electronic documents via Internet, comprising user-end access unit (16) and output unit (24) which is allocated to said output unit. A received document contains software instructions which can be executed through the output unit and which contains a designation of a file or to a path in the data transmission network. Components of the document are altered using this designation, whereby it is being prepared by a server-end deconstruction unit (26) so that it is only suitable for use in the form provided for the user after the software instruction has been executed. A server-end reconfiguration unit (28) is configuring software instructions or document components in such a way that when the document is received by the user again another access operation have to be used in which loaded instructions or document components are modified.

The invention relates to a device for the protected output of an electronic document via a preferably protected public data transmission network, in particular the internet, with the features in the preamble to claim 1; in addition the invention relates to a corresponding procedure.

In prior art a generic-type device of this type is realized by a PC, for example, with which known internet data and communications protocols may be used to access an internet server and with the user-end (local) PC being provided with a suitable data transmission and access function (browser) for this purpose.

To be more precise, known access to an internet server by the user-end access station (PC) takes place in such a way that—with a physically established data connection to a suitable internet service provider—the user can make contact with the desired server by entering an associated, individualized address and then a data communication process takes place in a way regulated by known internet protocols in such a way that the user locally receives electronic documents provided by the server, prepares and displays them using his access unit and his local PC also enables him to transmit associated access commands, file names etc to the network's server unit by a suitable method of inputting (keyboard) or identifying with a pointing device (mouse).

In current data communications via the internet, in particular the transmission of electronic documents in the form of a (screen) page in HTML format has become established, with the local output unit, for example the configured browser, enabling the HTML document with the associated content and format components to be viewed by the viewer on the PC screen in the way envisaged for the user (ie in the desired form, the desired appearance and with the desired content) or printed out on a connected printer.

In particular with more complex electronic documents (especially those, in which text to be displayed on a screen may also contain photographs or other graphical elements), however, the user-end HTML document downloaded on the first contact with the server may not immediately contain the associated image or graphics data, instead the electronic HTML document tends to contain a path and file option with which the user-end access unit may download an associated photograph file or graphics file from the server and the output unit then inserts the corresponding image or graphics data into the complex electronic document to be displayed.

A conventional HTML document page, therefore, not only comprises content and structural components (which may be converted directly by the output unit into a display) (ie, for example, text and its intended formatting), the described photograph or graphics file which is to be downloaded in addition should be understood as an additional programming instruction, namely an instruction to the user-end access unit to download the designated file, which may be found on the server under the specified name and the specified path, into the user-end output unit.

In the specific practical realization, therefore, the creation and display of a complex electronic document by an output unit consists of a large number of accesses to the server unit via the internet until the entire content of the electronic document (text, formatting, images, graphics, in particular also moving images) may be downloaded completely and displayed to the user.

To further increase the flexibility and variety of the possibilities for the creation and transmission of the electronic documents, also referred to as websites in this example, it is also known not only to introduce image and graphics components in a website in the form of additional files by the server, in addition text modules and further components of the electronic document are not transmitted exclusively as an HTML document on the first contact with the server, but designated via a special load instruction and downloaded separately as a file. To realize a more complex electronic document of this type, so-called script languages (a particularly common one is Javascript) or Visual Basic scripts are used as sequence of instructions structured like an interpreter language sequence of instructions, which are processed in sequence by the user-end access or output unit.

In order, in particular with repeated accesses to this same server file during a user session (ie an existing, continuing connection between the user-end access unit and server unit), to avoid having to repeatedly introduce identical electronic data via the internet, the user-end access unit is usually provided with a buffer unit (cache) which temporarily stores the most recently downloaded files or file contents and on a repeat request makes them available locally (and hence extremely quickly); this means that the, frequently time-consuming, repeated downloading of server data which has already been downloaded once becomes unnecessary.

Against the background of improved access control to the contents of an electronic document provided by a server which may require protection (for the purposes of this invention, “protection” should be understood in particular as the ability of a provider operating the server to control access to and handling of the electronic document with regard to times, locations, persons, functions or operating system/platform technologies and to prevent functions such as, for example, the copying, storage or printing of the electronic document by the user after downloading), known procedures of this kind are often inadequate and in particular the known cache technology ensures that even after one single, successful access, a user is able to copy (and hence reproduce) the electronic document obtained virtually unrestrictedly or make free use of the contents.

The known procedures for the transmission of electronic document data in the described way are hence only very restrictedly suitable for the controlled transmission and output of an electronic document; in addition to this, virtually all common browsers enable a user to display the basic HTML or Javascript commands on which the page structure of a document (or a page of a document) is based with comparatively little effort and hence to obtain not only the immediate content components, but also the path and file specifications for additional files to be introduced at the server end within the framework of the document.

Therefore, it is the object of the invention to improve generic-type devices, procedures and systems for the transmission and output of electronic documents via public data transmission networks, in particular the internet, with regard to the possibilities for more effective control of a user's usage and access and in particular to create the possibility of making multiple accesses to an electronic document and/or user operations, such as the copying, storage and printing of an electronic document dependent upon separate identification, authorization and/or compensation procedures.

The object is achieved by the device with the features in claim 1 and the procedure with the features in claim 14; advantageous further embodiments of the invention are described in the subclaims.

In an advantageous way according to the invention, it is attained by the invention that, for example, after a single successful access by a user to an electronic document provided by an internet server, further accesses and attempted accesses may be controlled, since, according to a preferred embodiment, after a single access to a server document file designated by means of a Javascript command, the file name of this document file changes and a repeated attempt to download it (such as is usually necessary, for example, for the user to store or print the electronic document) results in a failed attempt, unless a special agreement has been made between the user and the server-end provider, by means of which the user will be provided with meaningful and useful file contents under the modified address as well.

Since in particular the user-end cache memory has also stored, for example a buffered image file under its old file name, which is now invalid after the further access, the problem-free reconstruction of the originally received electronic document is not even possible by means of the cache: as the image file (still present in the cache) can no longer be called up using the now invalid file name, it is impossible to assemble the entire document.

For the purposes, of the invention, the “electronic document” is not restricted to websites that may be displayed by means of common browser systems; rather, for the purposes of the invention, an electronic document should be understood to be any text, image, video, music, game, program or multimedia files which may be transmitted via an electronic data transmission network, for example the internet, and used by users. Here, the “form envisaged” for the user should be understood to be any contents, any layout and/or any functions of a predefined electronic document, which are envisaged by the provider for an (authorized) user.

Correspondingly, the “deconstruction unit” acts for the purposes of the invention in such a way that the properties of the electronic document change compared to the form envisaged for the user, usually thereby reducing—completely—its usability and hence devaluing it. After this destructuring, therefore, from the viewpoint of the person providing the electronic document, there is no risk of the copying, storage or printing of this destructured document causing damage. Only when the associated programming instruction is executed by the local output unit will the electronic document be restored to its usable, envisaged form (hereinafter, also called reconstruction), with as described in the example, it being possible for suitable reconstruction instructions to be displayed or introduced by the actual programming instruction (for example, by a designated server file).

The reconfiguration unit also envisaged for the purposes of the invention ensures that the programming instructions required for the restoration of a usable electronic document are dynamized, ie they change after each access (or after a pre-specified maximum number of accesses) so that any further access attempts then do not result in the desired reconfiguration file or instruction and therefore the electronic document cannot be displayed to the user in the envisaged way.

As a result, therefore, the invention has attained an extremely effective electronic document access control which cannot be surmounted even by expensive cache systems at the user end.

In a further development, it is particularly preferable to realize the programming instruction for the purposes of the invention by means of a script language selected from the group comprising Javascript, Visual Basic Script, XML, XSL and HTML or similar. In particular a combination of Javascript commands, which call up XML files, facilitate a simple-to-realize and nevertheless complex access protection system for the server-end electronic data.

In a further development, it is also particularly preferable to download a large number of programming instructions for execution by the local output unit not locally (and hence accessible to local storage or buffering) but instead only to provide these programming instructions at the server for stepwise execution. This measure will further improve the complexity and therefore the security of the document protection attained.

In addition, it is particularly preferable to provide a user-end reconstruction (ie an execution of a programming instruction for the creation of an electronic document in the envisaged form) as a reaction to a manual interaction with the user, eg keyboard entry, mouse activation or similar, or with these preferably manual actions to trigger the envisaged change or reformation of the programming instruction for the purposes of the invention. In this way, it may be ensured, for example, that an electronic document is only assembled (reconstructed) in the envisaged way at the actual time of observance by a user (and then preferably also only in the currently visible segment), while otherwise the document components remain in the unusable form locally.

One possible application of the invention is only to permit users who have been identified and authenticated before accessing the server and/or have entered into an accounting dialog with the provider (for the purposes of which, for example, accounting data are transmitted in the form of a credit card number or similar) to perform special value-determining functions or operations, for example, printing or local storage. As a reaction to this kind of identification and accounting dialog between the associated, envisaged user-end and server-end units, the reconfiguration unit, even in the case of continuously changed programming instructions, would permit further correct (usable) access by a user authorized in this way or the reconfiguration unit would be deactivated as a reaction to a suitable identification and/or transaction process so that during the user session in question, no reconstruction or change takes place.

It is particularly preferred for the purposes of the invention in addition to form the programming instructions temporarily, ie to change them automatically in prespecified time intervals, in particular as a result of the impact of the reconfiguration unit, even if the user does not access a server (again).

In addition, it is particularly preferable for the deconstruction according to the invention to be performed by the deconstruction unit so that the deconstructed document components are present in the form of so-called semantic encoding with the operations of transposition, removal, addition and/or exchange of individual document components with an impact on the contents, eg words, frames, text pages, etc. As an alternative, it is also possible to perform the destructuring according to the invention by treating the electronic document in a different way, for example the removal of format commands or the performance of classical encoding operations, such as a XOR function for example.

In particular, if the deconstruction by the construction unit contains encoding, the programming instruction itself preferably functions as a reconstruction instruction or describes an access path for a server-end file with a reconstruction instruction of this type for the encoded (destructured) document.

According to a further development, the programming instructions, which are introduced by the server for local processing in the way described, then permit the control or realization of supplementary functions of the user-end access unit and the assigned output unit; for example, the envisaged time dependence of the programming instructions transmitted to the user may be established in this way.

The realization in accordance with the invention of (script-inserted) decoding operations for the restoration of a protected document for a user provides the additional possibility of providing supplementary (or within the scope of the transmitted scripts) scripts for output control, namely in particular to control or influence client-end operations, such as printing, storage, permitting or prohibiting copy and paste, etc; within the entire complexity of an electronic document already provided with retrievable scripts, this should not be conspicuous.

This kind of technology envisaged in accordance with a further development, namely the co-existence of function-determining scripts (in particular relating to different ways of using and outputting the document) with decoding scripts may, for the purposes of the invention, successfully prevent an unauthorized accessor (hacker) gaining access simply by deactivating a process engine for the script language in question. As it is also necessary for purposes of decoding or reconstruction, it is not easily possible to avoid the script-controlled output control by simply deactivating the script engine.

In this possible realization of the invention, the programming instructions envisaged according to the invention have a direct impact on the process environment at the client end; in addition to the extensively described scripts, programming or functional components, program classes, methods or similar are suitable for running as programming instructions in the relevant operating system environment (eg .DLL).

In addition, in a practical realization of the invention, the server unit providing the complete, usable document is decoupled by means of an upstream proxy server unit from the internet (or an accessing user), in such a way that a proxy unit of this kind, possibly by means of ASP (=active server pages) or PHP, performs the dynamic script dialog in accordance with the invention with the user or his access system, controls the user session and controls access to the server documents in the way according to the invention.

Hence, by means of the script-based, dynamized access control of a users access to electronic internet server files, the invention realizes effective access control, which by increasing the complexity of the (server-end) data access, the files and file references and the time-limited validity of server file names may be improved virtually as required, including with regard to an activation of the programming instructions for the process triggered by events at the user-end end or access actions (which is hence even more flexible).

Other advantages, features and details of the invention may be derived from the following description of preferred examples of embodiments and from the drawings; these show in:

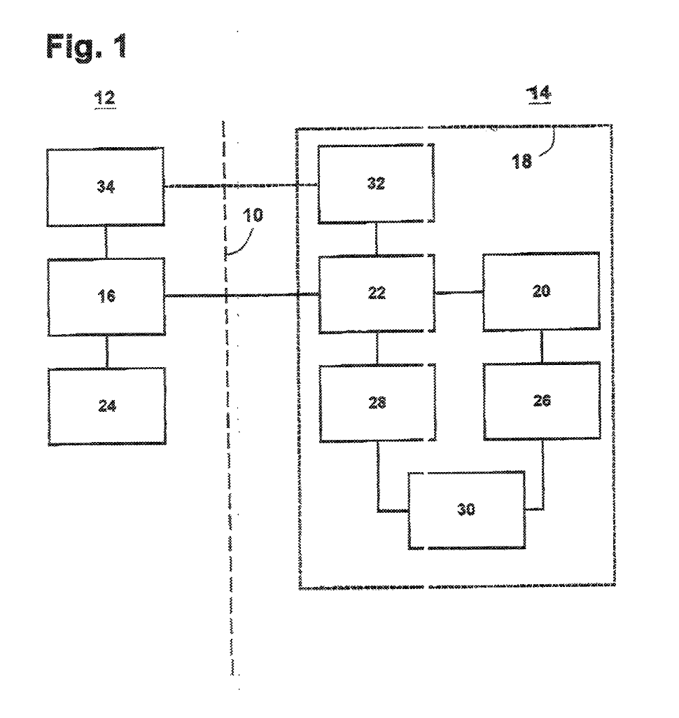

FIG. 1: a schematic diagram of a device for the protected output of an electronic document in accordance with a first embodiment of the invention

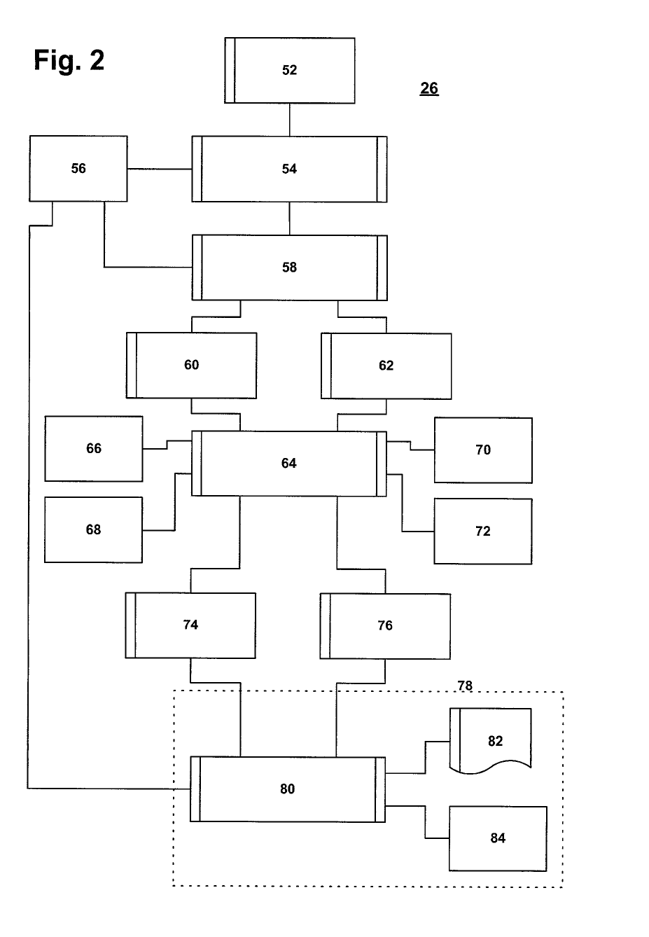

FIG. 2: a schematic diagram of functional components in the deconstruction unit in FIG. 1

As FIG. 1 shows, a symbolic electronic data transmission network 10 indicated in the diagram by a vertical line, in this case the internet, connects a user end 12 on the left with a server end 14 on the right.

To be more precise, a user uses an access unit 16, usually a PC, which by means of suitable hardware and software for internet data communications is equipped with the suitable protocols, accesses a server unit 18, which in this example of an embodiment has a document server 20 installed to provide electronic documents, for example electronic websites, containing text and images and a proxy server unit 22 connected upstream on the network side.

At the user end, the access unit 16 is connected to an output unit, which usually has suitable software for the reception and preparation of the electronic documents received via the network 10 and suitable hardware to provide a document of this kind to the user, for example on a screen or as a printout or similar. Common, commercial, software realizations are also known as browsers and are suitable for processing common document formats for electronic documents (HTML, XML, various graphics, video and multimedia formats, etc).

The units 10 to 24 described so far are used in an otherwise known way to perform internet communications in which the user accesses the document server via the access unit by inputting a suitable web address and then receives from the server electronic documents, possibly as HTML documents, which are then prepared for display on a screen by the output unit and made viewable to the user or which, by means of suitable control mechanisms, enable the selection and retrieval of further electronic documents or document pages.

Specifically, an electronic document is assembled for viewing by the user by means of HTML commands in an electronic document, which the user receives after the first contact with the document server 20 (via the proxy server unit 22). The functions of the output unit 24 (or the associated browser software) then convert the HTML document into suitable text or associated formats on a screen.

In addition, an HTML document usually also contains path details or download comments for further electronic files and contents, such as graphics and photographs, which are not downloaded directly with the HTML document, but which instead, on the sequential processing of the individual HTML operations at the user-end, lead to one (or several) repeated invocations of the server unit, with the object of also downloading the new, additional files at the user end.

These steps which are already known result in the appearance of the electronic document at the user end, assembled by a large number of document components, which either originate from the original HTML document or, by means of further server accesses and the further data obtained thereby, are added stepwise to the document. The cache usually assigned to the access unit also ensures that the already fairly complex document downloaded in this way is buffered in an otherwise known way.

However, according to the invention, within a prespecified time, for example a few minutes and/or on a repeated attempt to access the server unit by the user, there is a change to the server-end specific file or path name in the form implemented with the HTML document received at the user end, for example as Javascript instructions with the corresponding path and file data for the server. The repeated attempt to access with the corresponding no longer current path and file data results in an error so that the repeated restoration of the complete electronic document at the user end is no longer possible (and due to the changed path or file data, it is also impossible for the cache at the user end to reconstruct the downloaded document from its buffer memory). Instead, it would be necessary to transmit new data from the server, which then lead to the re-establishment and re-display of the document.

A particularly suitable environment is the known script language, Javascript, which in addition, in the example of an embodiment shown, is not transmitted in full with its individual commands or instructions to the access unit (for processing by the output unit), but remains at the server end and may only be processed by the user-end access unit stepwise or by means of commands.

As a result of this, it is also particularly simple for the purposes of the invention to modify the relevant Javascript commands provided at the server end (for example, as a reaction to an access already made) or to change their content and hence achieve the desired security effect.

Particularly suitable as additional data to be transmitted from the server for the electronic document to be displayed at the user-end is also the format XML.

Comparable to HTML, XML is a document format which is able to transmit text or other information, including format commands, for display at the user end, with in particular XML having the advantage that it is particularly simple and flexible to call up and process using Javascript commands.

Constructively, the procedure described is realized in this embodiment of the invention in that the document server 20 or the proxy server unit 22 is assigned a deconstruction unit 26 or a reconfiguration unit 28 which accesses a storage unit 30.

To be more precise, in the way according to the invention, the deconstruction unit 26 dismantles an electronic document stored in the document server into unconnected (destructured) individual parts and individual components so that the establishment of a complete, usable document is not possible with the associated reconstruction instructions. These reconstruction instructions, which may be realized in particular also in the form of Javascript commands, Javascript path references, XML commands or similar, are stored in the storage unit 30.

The reconfiguration unit 28 assigned to the proxy server unit 22 is now able to perform the adaptation or change to the commands with which the electronics documents are established at the access side or document access is generated. In other words, in this example of an embodiment, the reconfiguration unit 28 changes the Javascript commands in such a way that the repeated call up or access generates another path or another file name and performs a corresponding assignment or coordination corresponding to the content of the storage unit 30.

The reconfiguration unit 28, therefore, should be understood as an additional function of the server unit, which changes—otherwise known—static, ie unchanging programming instructions in the form of Javascript, DHTML or other commands and instructions depending upon user actions, accesses and/or time, so that the objective of security according to the invention is achieved. No such unit is provided in prior art so that the corresponding programming instructions remain unchanged. The principle of the “dynamization” of the server-controlled user-end instructions on which the invention is based should also be understood in this way.

If we understand the deconstruction or breakdown of an electronic document into individual units which are unusable without reconstruction to be encoding, the Javascript commands enable the reconstruction and hence the decoding. However, the dynamization of the Javascript commands achieved by the reconfiguration unit 28 again makes the possibility of decoding at the user end temporary and dependent upon a prespecified number of access attempts. This significantly increases the difficulty at the user end of generating a complete document at a specific time, for example for unauthorized forwarding or storage, in particular if manual interventions by a user to display a document, for example the activation of the mouse or scrolling the screen, only enable the reconstruction according to the invention.

To be more precise, the invention means that the Javascript commands accessible from the user end (as an alternative DHTML commands or similar may be called up or executed) enable functions in the form of a program to be performed at the user end which have a direct impact on the course of the user session or the content of the output or display accessible to the user. For example, a reference to a file, which is tracked by the user-end access unit, could itself contain a program which is then executed on the access unit or the output unit and runs there. In this way, the function described, namely, for example, the effect that only the text visible on the screen is non-encoded, but the rest of the text of the document is encoded, may be realized and the intended security objective further increased. This is based on the fact that usually these kinds of programs or instruction sequences introduced by the server end by means of the file or path access are not stored or buffered at the user end, so that a user-end reconstruction is extremely difficult, if not completely impossible.

With reference to FIG. 2, the following describes an advanced realization of the deconstruction unit 26 for the preparation and encoding of a document.

Here, FIG. 2 shows in a schematic block diagram the structure of a code-generating and administrative unit with the associated functional components for the purposes of the invention which may be used with the technology of semantic encoding to convert electronic documents to be protected into protect volume files, such as HTML files and the associated key files (as a basis for the scripts or programming instructions).

Here, the embodiment described in connection with FIG. 2 in particular also permits not only the (leading to the original correct dataset on restoration) generation of a key dataset, but a large number of key datasets, so that again this aspect of the existence of a large number of possible codes (of which again one also leads to a result with the correct, and not only apparently correct, content) is able to further improve the protection of the invention.

FIG. 2 will be described using the example of an electronic text document in a usual format (eg Microsoft WORD) and created with suitable text editors. The text document comprising the sentence:

Peter goes at 20.00 hours to the station. The train is punctual.

is stored in a storage unit 52 according to FIG. 2 and is to be encoded in the way to be described in the following by the action of the other functional components shown in FIG. 2 in order to be restored dynamically and script-controlled for the purposes of the invention.

A read/access unit 54, which works together with a format data unit 56, connected downstream from the document storage unit 52 identifies that the above-mentioned document stored in the storage unit follows the MS-WORD format structure (ideally, the format data unit 56 contains all format and structural information for common data formats) and uses this (file-related) format information to access the text document in the document storage unit 52. The analyzer unit 58 connected downstream from the read/access unit 54 is now able on the basis of the document information read by the read unit 54 to read and evaluate this, with the analyzer unit 58 dismantling the electronic document into its individual information components on the one hand and storing these in an information component storage unit 60 (in this example, this would be the individual words) and also identifies the document structure as a structure of two sentences separated by full stops and stores this document structure, dismantled, in the document structure storage unit 62. The content of the unit 62 is, therefore, given the character of a document-specific meta-file, which subsequent encoding processes will also be able to access (possibly selectively only).

Specifically, the content of the document structure storage unit could look as follows after the analysis of the original document by the analyser unit:

Sentence 1 (1, 2, 3, 4) Sentence 2 (1, 2, 3)

while the information component storage unit 60 contains information components corresponding to this structural analysis:

(1.1) Peter

(1.2) goes

(1.3) at 20.00 hrs

(1.4) to the station

(2.1) The train

(2.2) is

(2.3) punctual

With this important preparation for the subsequent performance of the encoding operations, it is now possible to perform the basic operations of semantic encoding on both the individual information components (in this example, the individual words) and on the sequences of information components or structures, namely transposition, removal, addition, or exchange. Here, an essential protective effect of the semantic encoding in accordance with the invention consists in that these operations cannot be performed arbitrarily, instead they are performed with observance of the rules of grammar, syntax and/or format, so that the result of the encoding appears (ie without an examination of the content) to be correct, in other words, it is not evident that this is in fact an encoded result.

In this example of an embodiment, the encoding unit would produce the following text from the above-cited electronic document:

Thomas comes at 16.00 hrs from the graveyard. The train is punctual.

Without knowledge of the true content, this sentence appears to be an open non-encoded result, so that an essential, protection-justifying effect of the invention consists in the mere fact that as a result of this text, a person accessing it would not even gain the impression that it was encoded and hence would refrain from accessing the text from the beginning.

Specifically, in this embodiment of an example, by means of the action of an equivalence unit 70 (which in its simplest version could be understood as a table or database of equivalent, ie. corresponding and exchangeable, terms), the following may be performed: the content component “Peter” in the original document has been replaced by the grammatically equivalent content component “Thomas”, with the sentence structure and grammar being retained, but the sense of the original document being destroyed. In a similar way, the content component “goes” in the original document has been changed to the equivalent component “comes”, the content component “at 20.00 hrs” has been replaced by the “at 16.00 hrs” (here, it was determined by means of the action of the equivalence unit that numerical data in the form of a time were involved, so that manipulation within the permissible times was possible) and the content component “to the station” has been replaced by the content component “from the graveyard”. Here, a semantic control unit 72 also connected to the manipulation unit 64, which influences the encoding operation described, ensures that the encoding result “ . . . comes . . . from the graveyard” is grammatically and syntactically correct, insofar as it cannot be identified as having been manipulated. (The word “to” would also have been correct here). The manipulation unit 64 and the interacting equivalence unit 70 and/or semantic control unit 72 also determined that the content component “the train” in the following sentence is in a contextual relationship with the newly introduced content component “graveyard” in the preceding sentence, so that even without the encoding of the second sentence, a completely different meaning (and hence an encoding effect) is obtained.

As the result of the simple encoding operations described, the result of the encoding

“Thomas comes at 16.00 hrs from the graveyard. The train is punctual.”

is output as volume data and stored in a volume data storage unit, while a key permitting reconstruction (in this example, information on the transposed words with their position in the sentence and in the relevant terms regarding content) is stored in a key data storage unit 74. Correspondingly, the associated key file for the storage unit 74 may look as follows (in the following example, the reconstruction unit interprets the script command EXCHANGE to perform the transposition identified in the argument):

EXCHANGE (1.1: Thomas)

EXCHANGE (1.2: comes)

etc.

Here, suitably the vocabulary of the command language is itself dynamic and may be changed by the functions of a scripting language; in this way, the EXCHANGE command could itself be replaced by another arbitrary expression.

In accordance with another preferred embodiment of the invention, it is envisaged that a large number of key files will be generated of which, however, only one will generate the correct reconstruction result. Correspondingly, key file 2 could start as follows:

EXCHANGE (1.1: Rüdiger)

(rest as key file above);

Key file begins with

EXCHANGE (1.1: Claus)

etc.

In the embodiment in FIG. 2, an output unit 78 is also connected downstream to these two storage units, which in a particularly simple way prepares the key data 74 in the form of a script and can output it as a playable script file 84; this is performed by the agency of a conversion unit 80, which, in an otherwise known way, generates an (HTML) volume document 82 corresponding to the encoded version from the volume data in storage unit 76 and from the index or reconstruction data in the storage unit 74 a structural description, script, eg as JavaScript, XML, VB-Script which may be executed independently within a suitable process environment and which may then be independently processed during the execution of the volume document 82 and returned to the original, non-encoded form.

It is self-evident that here the above words or sentences given as examples only of the semantic operations could also be other components relevant to the content or content components of an electronic document, for example images, graphics, graphical elements or magnified letters within a page, format commands, tables or other structural elements. All these may in principle for the purposes of the invention be suitably manipulated by the semantic encoding operations envisaged in accordance with a further development and then restored dynamically by means of (dynamic) scripts based on the reconstruction data.

Even though HTML is a particularly suitable format for the volume document 82 (which then for the purposes of the invention after the performance of the semantic encoding described as an example corresponds to the final-structured electronic document according to the invention), in principle, all types of format which may be received and displayed together with the programming instructions (scripts) according to the invention on the user-end access unit are feasible for a document format of this type.

In addition, the schematically shown embodiment shown in FIG. 2 is suitable not only for generating one key file for the storage unit 74 (or as a playable script file 84), but also a large number of these, of which ideally once again only one will produce a factually correct result with regard to content, while other key files as scripts trigger a decoding process which, although it produces a meaningful (and hence apparently correct) result, does not have the same content as the original version. Once again, this provides a further increase in the encoding security. Here, it should be immediately evident that even slight deviations in content completely destroy the (forming the actual value for a user) sense of the original document, so that possibly only slight modifications or a low number of encoding operations (followed by a correspondingly small script file as key data) are required to achieve the envisaged object of protection, right up to the above-mentioned non-encoding of the original file, whose protective function is only derived from the circumstance that the person making the unauthorized access is unsure whether he is dealing with open content (ie corresponding to the original file) or with encoded content ie not corresponding to the original content.

A particularly elegant way of generating a large number of (similar) key files consists in using a script-type key file which, with added parameters (eg index or sequence data), supplies different decoding results, with, within the scope of the described further development of the invention, all results being apparently correct, but only one corresponding completely to the content of the original. If, for example, these added parameters perform a sequence manipulation on whole sentences (with a text document) using an otherwise known cyclic permutation, precisely this object would be achieved: a large number of key files generates an apparently correct result, but only one file contains the actually correct sequence of the script-controlled encoded and decoded sentences according to the invention as text components.

As mentioned, the invention is not restricted to the example of text files described. For example, it is particularly suitable for encoding any other types of electronic documents in the way described in principle, as long as these electronic documents have a suitable structure of content components for the basic operations of transposition, removal, addition or exchange. Typical applications include in particular music files, which are usually in MP3 format, where it is possible within the context of the invention to exchange, remove or transpose the data structures (so-called frames) specified by the MP3 format individually or in blocks (ideally also by time or section, relative to the piece of music in question). The same applies to image and/or video files, because the usual, known data formats are also based on a sequence of frames as content components (in the case of images or electronic videos, these are the individual images in question), which may be manipulated in the manner according to the invention.

Other possible and favorable further developments of the invention envisage that a reconstruction file, in particular in the form of a script or similar, in ASCII or HTML format, is present. In particular with regard to a firewall protecting a client and/or server unit, this offers simplified possibilities of penetrating a firewall of this type undisturbed.

Another advantageous further development of the invention envisages embedding a reconstruction file suitably in electronic document data (of the same or another file type) and in such a way that the format and (reproduced) content of a guest file of this type remains unchanged; in a particularly advantageous way, an area of the guest file which does not have a directly effective content, eg commentary or information areas, is suitable for the concealed reproduction of reconstruction files of this type, with the objective of further increasing security.

In particular, the option of realizing the reconstruction files in accordance with the invention as scripts offers numerous advantages: for example, script-controlled merging within the context of the invention improves the flexibility or further increases security due to the fact that not only one script file as a reconstruction file facilitates the restoration of the non-encoded form of the electronic document by the merger, but that a large number of scripts as reconstruction files is needed, which, for example, cover pre-determined time segments of the electronic document and are then called up in succession. As an example, the invention may be realized so that in each case a script file as a reconstruction file for a time segment of about 30 seconds of an MP3 piece of music permits reconstruction and then a further reconstruction makes the (again script-controlled) call up of a subsequent, further script file necessary. In addition to an increased security effect, this provides possibilities for the context-dependent generation or reconstruction of the original document, including the possibility of restoring different variants of the original document in a context-dependent and selective way.

An essential object of the reconfiguration unit 28 which works with the deconstruction unit 26 is to dynamize the scripts generated as a result of the above-described encoding operation (file 84 in FIG. 2), ie, with the aid of these scripts to achieve an always variable restoration of the original document at the user end.

This may take place particularly suitably in that, in cooperation with the conversion unit 80 (FIG. 2) ( . . . )¹ the deconstruction unit, different script files 84 are continuously generated and linked with the basic reconstruction data in such a way that only a current version of a script file 84 at the client end (ie by running or execution in the access unit 16² leads to the correct electronic document in the restoration, it is possible that this may require a further interaction between the reconfiguration unit 28 and the deconstruction unit 26 at the server side as well, namely to the effect that volume and reconstruction data have to be regularly changed or adapted. ¹ Tr note. there appears to be a word (or words) missing here ² Tr note Final bracket is missing in the original text

Since, going beyond the protection or security effect, one of the intended purposes of the invention is to enable the provider at the server end to control user accesses, and here the provider may in particular have a commercial intention of only making specific file contents and/or operations accessible to authorized users after a previous transaction process, an accounting unit is envisaged at the server end, which in an otherwise known way interacts with an identification, authentication and accounting unit 32 correspondingly assigned to the access unit 16 at the user end. To be more precise, after the appropriate transmission of suitable payment information for a user, for example credit card data, the possibility is created of the user obtaining special access or usage rights for an electronic document, which would otherwise be made impossible for an unauthorized user in the specified way. The same also applies to a foreseeable user group and/or rights management at the server end in the server unit, not shown in the diagram, which is able to manage access and usage rights appropriately and possibly only enable members of a user group to access certain documents in encoded form.

For the authentication or identification of a user, here it may be particularly favorable to evaluate access data or script information, with which the user himself accesses the server end, to see whether these—obtained in an authorized manner—originate from (immediately) preceding, possibly almost real-time sessions and identify a correct access.

The invention is not restricted to enabling the programming instructions to run via browsers or similar internet access systems. Rather, in particular also encompassed by the invention are further, document-specific environments which control or influence the contents of programming instructions and which are not special internet browsers. For example, the invention also encompasses the provision of text processing programs for the realization of the invention with a special process unit which then effects the functions according to the invention for the reconstruction of

the encoded data according to the invention and electronic files (a specific example could be text processing, which by means of a process unit has a script or macro language effecting the encoding effect, for example VBasic).

As a potential further development of a general approach of this kind when using a (generic) document display unit together with a process unit for scripts, it is particularly suitable not to perform the execution or the start of the scripts automatically after the downloading or call up of a relevant script by an HTML page, as is the case, for example, with an internet browser, but rather to make the script call-up dependent upon events in the relevant process environment or process software at the client end. For example, it is particularly suitable to change the appearance, structure, text or image composition of an electronic document at the client end by the script in that the script effecting this manipulation is started as a reaction to an event of this nature; typical events are, for example, the events “onhide” or “onshow” with the Microsoft Windows or Internet Explorer object model, comparable to an interrupt: only as a reaction to the display (or hiding) of certain document passages would the scripts linked to these events be initiated and hence contribute to the additional security effect for the purposes of the invention. This further development of the inventive concept is based on the approach that in particular with a script call up by an HTML document on the downloading, a quasi static condition occurs as soon as the scripts are executed and by (improper) access to the DOM (document object module) for the document in question, theoretically an attack could take place; on the other hand, event-controlled dynamization, particularly during representation or display operations at the client end following the complete downloading of the document from the server, enables the DOM environment to be dynamized and hence protected more effectively from an improper access.

A further development of the concept could be that the (whole) electronic document is understood as a combination of different hyperlinks, namely realized as a quantity of (once again script-controlled activatable and changeable) references to other document areas and content elements. Correspondingly, an activation of the hyperlink (event “ondick”) causes a change in the document in the DOM.

Protection against automatic read-outs from the DOM of an electronic document achieved in this way is then particularly difficult if the entire tasks (eg on a screen) may be made visible immediately. In such a case, there may be no screen areas which, during operations such as “onhide” or “onshow”, supply an event which could effect a dynamic change to the values within the “DOM”.

In order to achieve an event-triggered activation of scripts in such a case, values are added to the DOM at positions which would typically appear outside a visible area (for example, on a screen display), but could never actually be made visible. However, if then, for example by the user activating a scrollbar, the “onshow” event for this kind of added object is generated, the activation of a script and hence a change to the values in the DOM takes place in such a way that, for example, similar objects are inserted at a different place outside the visible area and within the DOM. Advantageously, these objects could again contain scripts which after emptying an “onshow” event contained therein, cause the object in question to disappear or move.

A similar approach within the scope of a further embodiment of the invention may be applied to a subset of the DOM: here, a document could be seen as a set of surface elements, which together represent the entire document, but with areas lying within the individual surface elements, which are not visible, because they would position themselves outside the visible area. If, for example, areas of this type are activated by means of a “mouseover” operation, an associated event may have changed the data in the corresponding DOM subset.

For the security aspects of the invention, this means that an unauthorized accessor (hacker) can only use this type of information context-sensitively, with however, the context only becoming clear to him after a thorough analysis.

A practical advantage resulting from this invention is also found in that, see the configuration and the interaction of the functional units according to FIG. 1, deconstruction unit 26 and reconfiguration unit 28, the units work dynamically with each other and therefore the storage unit 30 should only be understood as a buffer. Although associated reconstruction data in the form of corresponding programming instructions for and/or by the reconfiguration unit are generated as soon as a repeated (new) encoding of the associated electronic document takes place namely, for example, as the consequence of the passage of time and/or the action of a user, for example a repeated attempt at access, no further storage, for example at the user end, will take place. This will not only save storage space, but, in particular, also facilitate the updating of the electronic document involved.

In the following, another specific programming realization of an embodiment of the invention is described which may be realized with the aid of XML and Javascript (only the essential commands or their sequence are described).

Here, it is assumed that the user downloads a page of an HTML document from the server unit as a starting document, which contains a call for a Javascript (“js” as a file identifier) and the same Javascript programming instructions are again available at the server and may be called up therefrom.

A corresponding section-by-section program code for a corresponding Javascript program sequence which is then processes at the user end by the access unit could then look as follows:

| | |
|---|---|
| if | session (“count: s”) = “0” then |

session (“count: s”) = “1”

XMLDoc.async = false;
// calculation of the dynamic document name schedule.xm12.asp
XMLDoc.load (“schedule.xml” + (1+1) + “.asp):

XSLDoc.async = false
XSLDoc.load (“schedule.xsl.asp);

| // | parsing of the XML file |
|---|---|
| // | here the downloaded file is the new element |
| | result = XMLDoc.documentElement.transformNode |
| (XSLDoc.documentElement): | |
| // | replacement of the encoded test |

encoded.internalHTML = result;

else

alert (“*** error message ***”);

end if.

Evidently, here a check is being performed to see whether the instruction sequence (script) has already been downloaded and, if this is the case, a suitable error message is generated.

The command XMLDoc.load then results in the downloading of the dynamically calculated document name, in this case the document name schedule.mx12.asp and with the result-instruction, the content of the file schedule.xm12.asp will then be incorporated in the document.

In this example, the additionally called-up module schedule.xm12.asp only contains text modules which may then called up as appropriate; as with the script shown above, however, it is again possible to suppress the multiple reading of the same file by means of an if-instruction, for example.

As a result, therefore, the following is achieved by the example shown: on the one hand, the script shown above ensures that it can only be performed once; another attempted access would fail and result instead in an error message. On the other hand, by means of the displayed script and a simple calculation operation (1+1), another file name is dynamically operated, namely the file name schedule.xm12.asp, which is then accessed and which then supplies the desired text for incorporation in the document. However, this dynamically generated file name is also dynamic and temporary and so this file may also only be called up once and, as evident to an average man skilled in the art, the procedure shown offers a wide variety of possibilities for varying the generation and/or calculation of a file name of this type.

Another possible further development of the invention consists in that, with the aid of an encoding procedure, numerous different reference or hyperlink names are generated, which, however, may be interpreted at the server end after decoding in such a way that they lead to the same end. For example, to this end, the hyperlink is expanded by a (at the server end) file by a defined identification, preferably randomly controlled, for example by the specific file name being expanded by a randomly determined character (and hence instead of, for example, 10 characters has a character string of 18 characters). After encoding, this produces an independent, completely new encoded path name, which may also be transmitted as such at the client end or used by the client to call up the next document page or document component.

At the server end, this encoded path name may then be encoded again and, by removing the last seven positions, the original unique name leading to the objective is formed. This measure envisaged within the scope of a further development of the invention would have the advantage that the generation of a large number of possible path data to increase security against improper accesses by the client side and preferably also, possibly by a continuation of character strings attached to the original path, the recognition of no longer valid path data or file requests by the client—but completely non-transparent to it—by the server side would be possible. Depending upon the situation, a symmetric or asymmetric code may be used.

In accordance with a preferred embodiment, within the scope of the programming instructions in accordance with the invention, (scripts) algorithms will be used which can cope with various configuration situations and possible attack situations by a client end. For example, it is first of all possible by means of a server-induced script inquiry to determine whether, and if so which, a script language will be understood at all or usable at the client end. In addition, for example, a specific operating system environment or platform may also be tested at the client end. It is also possible by means of a script (which has already been received at the client end and is started at different, preferably variable times) to determine whether a relevant client is at least in online contact with the relevant server or whether an offline situation (which is potentially more hazardous with regard to attacks) exists; in accordance with this determination, the effects triggered by the scripts (eg modifications in the display) may change. A particularly simple way to determine whether on-line contact actually exists may be implemented by means of the script structure so that within the script a query is sent to the server and a specific response awaited (so-called challenge and response).

In principle, it is possible for the purposes of the invention that the provision of the programming instructions not only permit the correct (re-) establishment of the electronic document, it is also—script-controlled—possible to modify the content and format of the document, in particular to a reconstructed document page. For example, it is in particular possible to integrate continuously different path data and/or hyperlinks in an HTML code and hence to force the re-downloading of the file (by an automatic read process); therefore, there are no automatically usable references to the next or previous page. A simple variation of a reconstructed page versus a previous reconstruction (eg a change to the front or similar) also prevents an algorithm used for the purpose of an improper access or decoding establishing a concrete relationship between pages, possibly identifying two pages with the same content as being the same (identical).

In addition, non-uniform structural elements or a non-uniform layout of a reconstructed (or apparently reconstructed) document may, by means of suitable script control, be a tip to a user (of an illegally obtained document) that the contents of the document in question have been encoded by possibly sense-changing manipulation.

To further improve the (security-providing) complexity for the purposes of the invention, additional content elements may be integrated into the electronic document by means of script codes or script control, with these contents only being identifiable by a user and not machine-controlled (as, for example, they were added to the script code randomly from a manually created file). In the case of the correct display of the electronic document, no—script-controlled—display of these additional content components (cases) takes place so that proper use is problem-free for a user. On the other hand, an unauthorized accessor and/or a hacker who wishes to forward the document in an authorized manner, would have to check the contents of the document or the script code and then remove the additional components manually.

Generally, this invention encompasses the provision of the greatest possible flexibility for handling the downloading and starting of scripts and/or script-controlled data at the client end; in particular, the programming instructions according to the invention also encompass manipulations and/or influences of client-end program functions of the representation or process unit, for example the possible activation and/or deactivation of a printing or copying function or similar or even the selective control and manipulation of different representation layers on a suitable image output unit.

Therefore, the invention can even encompass the general concept that—script-controlled—the functions of the user-end (client-end) access unit and/or of the assigned output unit may be directly influenced by the programming, with, in addition to scripts, in particular it also being possible to transmit and start (executable) program modules, program classes or similar at the client end as programming instructions.

Precisely with regard to offline operations, the result of this concept that a document to be displayed offline may be displayed directly in an offline display component protected with prespecified scripts at the server end or however, that an offline display component of this type in the form of an offline, (ie local) server unit, itself contains a script generation unit which is able to generate scripts for the purposes of the invention in order to display documents in a protected and script-dependent way or to prevent a reproducible access via a script debugger or via the DOM.

1. A device for the protected output of an electronic document via a preferably protected public data transmission network, in particular the internet, with
a user-end access unit (16) for access via the electronic data transmission network (10) to a server unit (18) offering the electronic document for downloading,
an output unit (24) assigned to the user-end access unit to receive and output the electronic document in a form envisaged for the user,
with the received document having at least one programming instruction which may be executed by the output unit for the output and containing a file designation and/or a path in the data transmission network and/or a display form for the electronic document, with it being possible to download and/or change the document components of the electronic document by means of the designation,
characterized in that
the electronic document is prepared by means of a server-end deconstruction unit (26) and deconstructed with regard to the document components so that it is only usable in the form envisaged for the user after the execution of an assigned programming instruction generated as appropriate by the deconstruction unit,
and a reconfiguration unit assigned to the server unit (28) is designed so that the programming instruction and/or the document components of the received document may be designed or changed so that the repeated reception of the electronic document by the user after a prespecified, limited number of other accesses, in particular after only one further access, effects a change to the instruction with regard to an associated file designation and/or a path designation and/or a display form and/or a change to the document components to be downloaded herewith compared to a preceding reception and output.

2. A device as claimed in claim 1, characterized in that the programming instruction is an element of a script language suitable for electronic processing, which may be processed and/or executed by the output unit, preferably stepwise.

3. A device as claimed in claims 1 or 2, characterized in that the programming instruction is realized by means of Javascript and/or Visual Basic Script and/or XML and/or XSL and/or HTML, with preferably a large number of instructions being provided at the server end for call up and execution by the user end output unit.

4. A device as claimed in one of claims 1 to 3, characterized in that the programming instruction is designed for user end access to a server-end file whose data content with the programming instruction is envisaged for the merger of the electronic document in the form envisaged for the user, with preferably the server-end file being an XML file and/or an XML data format file.

5. A device as claimed in one of claims 1 to 4, characterized in that the programming instruction is designed so that prespecified operating modes of the user-end access unit, in particular operating system parameters, possible executable script languages, on- or offline status, may be recorded and prespecified commands of the programming instruction dependent upon this recording may be initiated, with preferably a restoration of the electronic document taking place in a usable, context-sensitive or time-sensitive, version.

6. A device as claimed in one of claims 1 to 5, characterized in that the reconstruction unit is envisaged and designed to interact with a control unit assigned to the output unit and activatable by a user so that, as a reaction to a prespecified actuation by the user, in particular a change to a mouse or pointer position on a screen or a change to an image segment, the programming instruction is re-formed or changed or the programming instruction is executed to generate the electronic document in the form usable to the user.

7. A device as claimed in one of claims 1 to 6, characterized in that a server-end identification and accounting unit (32), which is envisaged and designed to interact with an identification and accounting unit assigned to the user-end access unit so that, as a reaction to an identification, authentication and/or transaction process with a user, the reconstruction unit forms or changes the programming instruction and/or the document components so that, even with re-formed or changed programming instructions or document components, the electronic document may be established in the form envisaged for the user by the output unit.

8. A device as claimed in one of claims 1 to 7, characterized in that the programming instruction is designed so that in the user-end access unit its execution is not automatically started as a reaction to a reception by the user-end access unit, but the execution of the programming instruction takes place as a reaction to a prespecified event during the operation of the user-end access unit, in particular a display command (onshow, onhide) or as a reaction to the actuation of a hyperlink preferably acting on the actual electronic document.

9. A device as claimed in one of claims 1 to 8, characterized in that the reconfiguration unit is designed so that after a specific time, the programming instruction and/or the document components are re-formed or changed, even if the user has not made any further accesses.

10. A device as claimed in one of claims 1 to 9, characterized in that the server-end deconstruction unit is designed so that the preparation and deconstruction of the electronic document is encoded by the transposition, removal, addition and/or exchange of individual document components with an impact on the content or encoded in the manner of an XOR function.

11. A device as claimed in claim 10, characterized in that the programming instruction functions as a reconstruction instruction for the encoded document or describes an access path to a file which may be called up at the server end which contains a reconstruction instruction for the encoded document and in addition preferably has additional functional commands acting on the user-end access unit and/or the output unit and/or is encoded itself.

12. A device as claimed in one of claims 1 to 11, characterized in that the reconfiguration unit is a component of a proxy unit connected upstream to the server unit relative to the data transmission network which is envisaged and designed to store and manage programming instructions, file designations, path designations and/or display form designations and is designed so that in the server unit there is no change to files and/or document components as a reaction to the reconfiguration unit, with preferably the proxy unit being designed for the process control of a user session with the server unit and for the management of rights and user groups for electronic documents offered by the server unit.

13. A device as claimed in one of claims 1 to 12, characterized in that a database (30) is assigned to the server-end deconstruction unit and the reconfiguration unit, which is designed to store and access destructured electronic documents, associated programming instructions and/or file names of programming instructions.

14. A procedure for the protected output of an electronic document via a preferably public data transmission network, in particular the internet, with the following steps:
access via the electronic data transmission network by means of an user-end access unit to a server unit providing the electronic document for download access and
removal and output of an electronic document by means of an output assigned to the user-end access unit in a form envisaged for a user,
with the received document containing at least one programming instruction which may be executed for output by the output unit and designation for a file and/or a path in the data transmission network and/or a display form of the electronic document, with it being possible to download and or change document components of the electronic document by means of the designation,
characterized by the following steps:
the preparation and destructuring of the electronic document with regard to the document components by means of a server-end deconstruction unit so that is only usable in the form envisaged for the user after the execution of an assigned programming instruction suitably generated by the deconstruction unit,
the formation and change of the programming instruction and/or the document components of the received document by a reconfiguration unit assigned to the server unit in such a way that a repeated reception of the electronic document by the user after a prespecified, limited number of further accesses, in particular after only one further access, effects a change to the instruction with regard to an associated file designation and/or a path designation and/or a display form designation and/or a change to the document components to be downloaded thereby compared to a preceding reception and output.
